(19) United States
(12) Patent Application Publication
(10) Pub. No.: US 2006/0248470 A1
(43) Pub. Date: Nov. 2, 2006

(54) Variable-rate scrolling of media items

(75) Inventors: Alvin Peter Lee, Oakland, CA (US); David Hendler Sloo, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/119,366

(22) Filed: Apr. 29, 2005

(51) Int. Cl. G06F 9/00

(52) U.S. Cl. 715/784; 725/43; 715/866; 715/863

(57) ABSTRACT

Variable-rate scrolling through media items is described. In an implementation, a method includes monitoring client interaction with a plurality of media items and varying a scroll rate of an output of the plurality of media items based on the monitoring.

### TECHNICAL FIELD

The present invention generally relates to the field of media items and more particularly relates to variable-rate scrolling of media items.

### BACKGROUND

The amount of media items that is available to users is ever increasing. For example, a user may have access to hundreds of television programs available via hundreds of television channels that are broadcast to the user. Additionally, the user may also view pay-per-view movies, order video-on-demand (VOD) content, interact with a video game, play music, and so on. In another example, the user may have access to a wide variety of local media items. For instance, the user may utilize a digital music player which can store thousands of songs, a digital picture repository having thousands of images, a library of digital movies, and so on.

Due to the sheer number of media items that are available to the user, however, the user's interaction with the media items may actually decrease. For example, when the user had a choice involving just a few television channels, the user was more likely to navigate through each of the channels to locate a particular television program of interest. However, as the number of channels increased, the amount of time needed to navigate through the channels also increased. For example, it may take the user over half an hour to manually navigate through each of the channels available from current television broadcasters to determine if a particular channel has a television program of interest. Consequently, the user oftentimes remembers just a few favorite channels and ignores the rest, thereby forgoing the use of the other television channels and television programs on those channels. In a similar example, the user may utilize a digital music player that can store thousands of songs. Again, however, it may be difficult for the user to locate a particular song, artist, or even genre of interest included in the thousands of songs. For instance, the user may select a genre and be confronted with an exceedingly large number of songs and therefore again have to spend a significant amount of time to locate a particular song of interest. However, if the user selects a particular artist, the user is limited to that artist and therefore may forgo the music of other artists.

Therefore, there is a continuing need for improved techniques for display and navigation through media items.

### SUMMARY

Variable-rate scrolling through media items is described. In an implementation, a method includes monitoring client interaction with a plurality of media items and varying a scroll rate of an output of the plurality of media items based on the monitoring.

In another implementation, a method includes configuring a display of representations of a plurality of media items such that a scroll rate of the display of one or more of the representations is varied based on one or more characteristics shared by the one or more media items and outputting the display for rendering by a plurality of clients.

In a further implementation, one or more computer readable media include computer executable instruction that, when executed on a computer, direct the computer to vary a scroll rate of a plurality of media items based on one or more characteristics shared by one or more of the media items

### BRIEF DESCRIPTION OF THE DRAWINGS

FIG. 1 is an illustration of a system in an exemplary implementation which is operable to employ variable-rate scrolling techniques.

FIG. 2 is an illustration of an environment in an exemplary implementation that is configured to employ the system of FIG. 1 for variable-rate scrolling of media items.

FIG. 3 is a flow diagram depicting a procedure in an exemplary implementation in which a scroll rate is adjusted for output of a plurality of media items based on monitored client interaction.

FIG. 4 is an illustration of an electronic program guide in an exemplary implementation in which a scroll rate of the plurality of media items is adjusted by adjusting a display size of one or more of the media items.

FIG. 5 is a flow diagram depicting a procedure in an exemplary implementation in which a scroll rate is adjusted based upon a characteristic of a media item output by a client.

FIG. 6 is a flow diagram depicting a procedure in an exemplary implementation in which heuristic data collected from a plurality of clients is utilized to vary a scroll rate of media items output for display by the plurality of clients.

The same reference numbers are utilized in instances in the discussion to reference like structures and components.

### DETAILED DESCRIPTION

Overview

Systems, methods, apparatus and computer-readable media for variable-rate scrolling through media items are described. Users have access to a wide range of media items. For example, current digital television offerings include hundreds of channels. The sheer number of channels, combined with the time it takes to tune to channels, however, discourages users from channel surfing. One alternative for users is to arbitrarily enter a number near the set of channels that are interesting to them, and jump to those channels and channel surf there, e.g., entering channel “300” and surfing through channels in the 300-400 range. However, this technique still limits the users' exposure to other potential channels of interest.

In another alternative, a “channel plus” (CH+) or “channel minus” (CH−) button of a television remote control is utilized to navigate from one media item of interest to another media item of interest. However, this navigation technique is onerous and lugubrious, especially as the number of channels continues to increase. For example, using traditional navigation techniques, as the user holds down the “CH+”, “CH−” or other incremental channel-browsing keys, an equal amount of time is spent browsing through each channel. Product designers, for instance, currently limit the rate of browsing so that a user can tell which channel is currently being browsed and thus release the “CH+” or “CH−” button at the right time. Therefore, a user that is only familiar with “CH+” and “CH−” navigation may eventually give up trying to locate a channel and/or is forced to look at a variety of irrelevant channels while navigating.

In a variety of implementations, variable-rate scrolling techniques are described. For example, a variable-rate scrolling technique may be employed to allocate different amounts of time for tuning to different channels or sets of channels. The technique may utilize heuristics set by a broadcaster, the user, or learned, to apply a rate value to a channel in a channel map. The rate value may indicate the amount of time that channel is displayed when navigating through the channel. For example, if the user never watches television programs between channels 200-299, channels within that range may be displayed for a lesser amount of time than the amount of time utilized to display other channels, with which, the user regularly interacts. Similar techniques may also be utilized depending on a characteristic of a currently viewed television channel, and so on. For example, if the user is watching a sporting event and wishes to navigate to another channel, those channels which are not broadcasting a sporting event may be displayed for a lesser amount of time than those which are broadcasting a sporting event. These techniques may be applied to a wide variety of media items, such as locally stored media items (e.g., songs on a digital music player), media items that are available over a network, and so on.

In the following discussion, an exemplary environment is first described which is operable to utilize the variable-rate scrolling techniques. Exemplary procedures are then described which may be employed in the exemplary environment, as well as in other environments.

Exemplary Environment

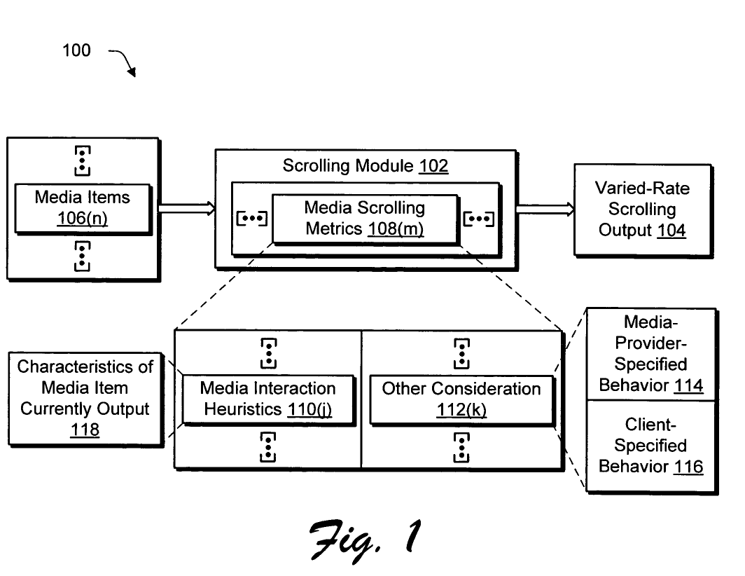

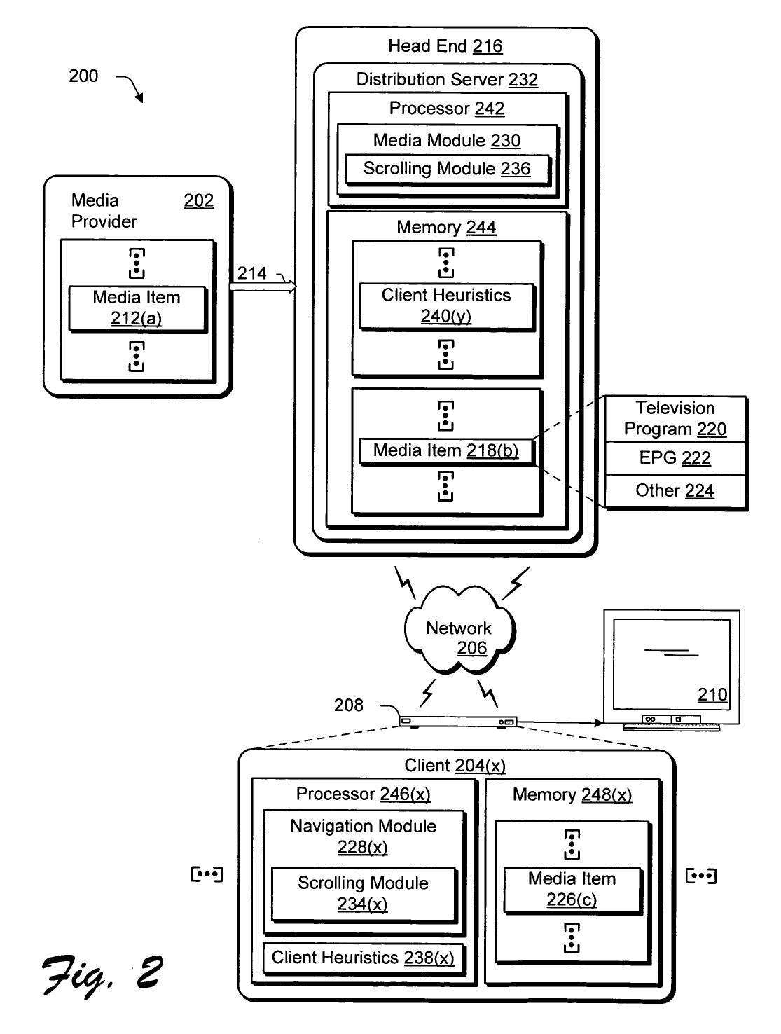

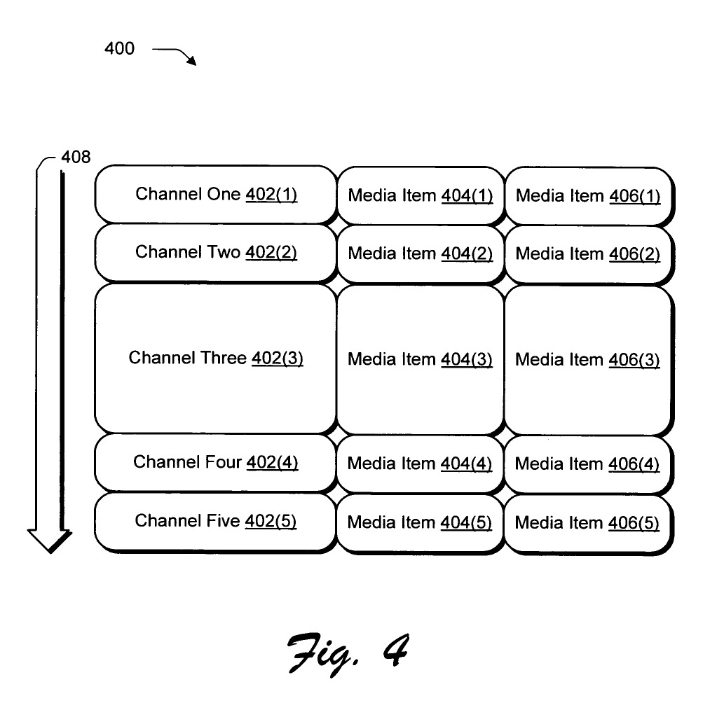

FIG. 1 is an illustration of a system 100 in an exemplary implementation which is operable to employ variable-rate scrolling techniques. The system 100 is illustrated as including a scrolling module 102 which is executable to provide a varied-rate scrolling output 104 of a plurality of media items 106(n), where “n” can be any integer from one to “N”. The media items 104(n) may be configured in a variety of ways. For example, the media items 104(n) may be stored locally on a client, obtained remotely over a network, may be configured as representations of other media items (e.g., an electronic program guide), and so on. Further discussion of media items may be found in relation to FIGS. 2 and 4.

In an implementation, the scrolling module 102 is executable to vary an amount of time utilized to output one or more of the plurality of media items 106(n) for display. The scrolling module 102, for instance, may deliberately and algorithmically vary a rate, at which, a display of the media items 106(n) is changed given a constant user input. For example, in a television environment, the user can hold down the “channel plus” (CH+) button and the client (e.g., a set-top box), through execution of the scrolling module 102, may display the channels at a varied rate, one to another. For instance, the channels in a first grouping (e.g., such as channels 300-399 for movie channels) may be displayed at a rate that is different than channel in another grouping, e.g., channels from 200-299 for sports-related channels.

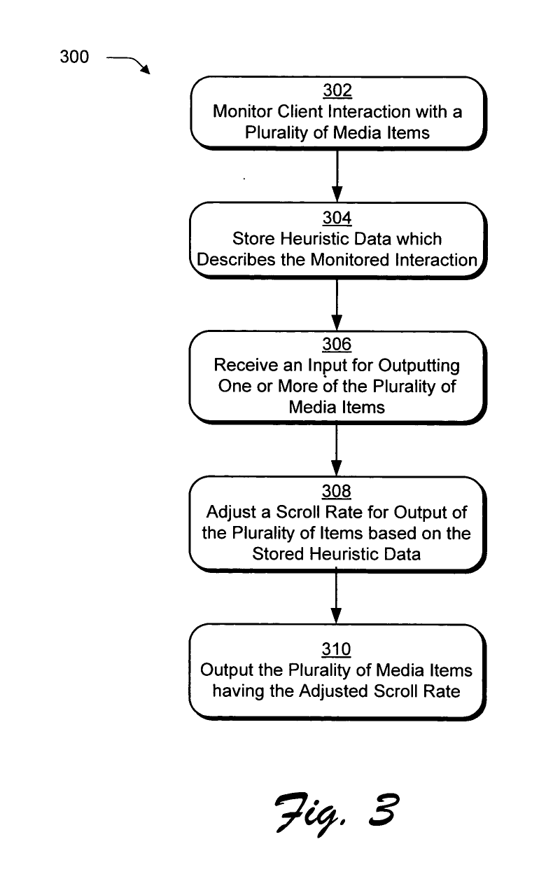

The scrolling module 102 is applicable to a wide variety of other navigation experiences, such as when the user is scrolling through an electronic program guide (EPG), paging through a part-screen preview panel, songs on a digital music player, and so on. The media items 106(n), for instance, may be configured for output on clients implemented as a video system (e.g., configured as a movie, television program, pay-per-view movie, video-on-demand, electronic book, and so on), music system (e.g., configured as a musical album, radio programs, and so on), game system (e.g., configured as a video game), and so forth. Therefore, the pace at which the media items are output (e.g., cells in the EPG, panel shifts between sequential displays of channels, songs output in a “scan” mode, and so on) may be varied in these instances to improve the navigation experience of the user with the plurality of media items 106(n). Thus, the scrolling module 102 may be executed in a variety of environments to provide a varied-rate scrolling output 104 of the plurality of media items 106(n), further discussion of which may be found in relation to FIGS. 3-6.

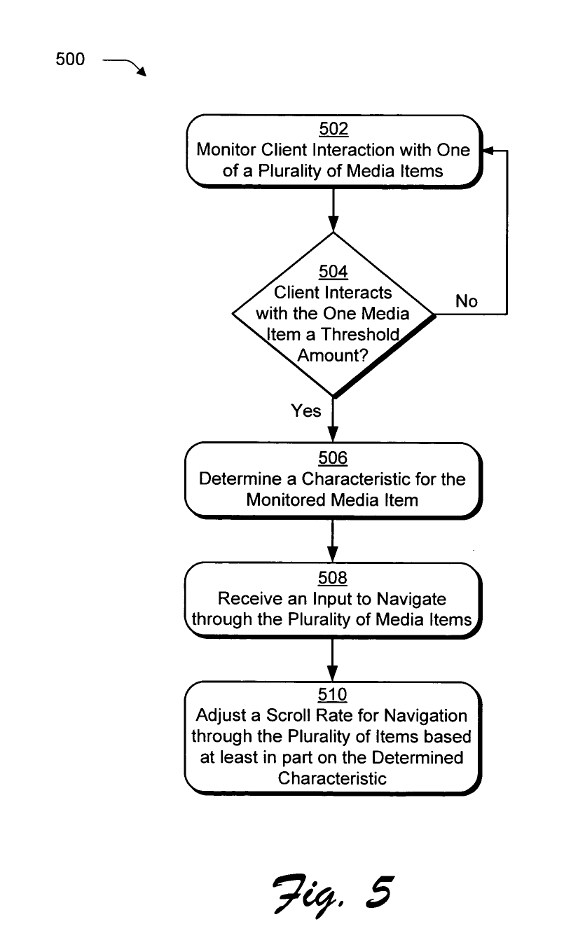

The scrolling module 102 may utilize one or more of a plurality of media scrolling metrics 108(m) (where “m” can be any integer from one to “M”) to determine how to vary the rate of the scrolling output 104 of the plurality of media items 106(n). For example, the media scrolling metrics 108(m) may include a plurality of media interaction heuristics 100(j), where “j” can be any integer from one to “J”, which describe interaction with the media items 106(n). For instance, the media interaction heuristics 110(j) may be based on an amount of time one or more of the media items 106(n) were selected for output, when the media items 106(n) were output (e.g., how recent), and so on. For instance, the scrolling module 102, when executed, may determine that the user never watches a particular channel for more than two seconds at a time, which may indicate that the user merely “flips” through this channel. The scrolling module 102 may utilize this determination to determine rate changes for scrolling through a channel map which includes this channel. In this example, the scrolling module may spend less time displaying the particular channel than other channels, with which, the user has interacted for a significant amount of time, e.g., over a specified threshold, further discussion of which may be found in relation to FIG. 5.

The scrolling module 102 may also utilize a plurality of “other” considerations 112(k), where “k” can be any integer from one to “k”, as media scrolling metrics 108(m). For example, the scrolling module 102 may utilize media-provider-specified behavior 114 to vary the scroll rate, such as:
whether the media item is new;
whether the media item is a special feature (e.g., a broadcast of the Olympics);
whether the media item is currently the subject of a promotion (e.g., the media provider is paid a fee for a longer display of the media item); and
viewing habits of other users (e.g., a television program is more popular than other television programs that are broadcast on other channels at the same time).
   Thus, a media provider may specify one or more considerations which are utilized to vary a scroll rate of the plurality of media items.

The scrolling module 102 may also utilize client-specified behavior 116 to determine rate changes for output of the plurality of media items 106(n). For example, the user may specify particular channels as a favorite, such as channels “103”, “105”, and “119” (which are the local stations); and channels “504”, “505”, “506”, “511” (which are movie channels). The scrolling module 102 may then browse through groupings of the available channels based on the favorites. For instance, the scrolling module may display each of the channels in a grouping from channels 100-150 and a grouping from channel 500-550 for a longer period of time than other channels which are not in these groupings. Further discussion of media item groupings may be found in relation to FIGS. 3 and 5.

In another implementation, characteristics of a media item currently being output 118 are utilized as a media scrolling metric 108(m). For example, a media item genre (e.g., a sporting event, news, and so on) may spread across a wide array of channels, but not across those channels' broadcast schedules. For instance, sporting events may appear all day long on certain sports-focused channels, but only at certain times on a general network channels. If “is it a sporting event?’ is used as the media scrolling metric 108(m), then holding down the “channel plus” (CH+) button might scroll through each of the sport events currently being broadcast, such as not just the sports channels, but also the network and premium channels that happen to be showing a sporting event.

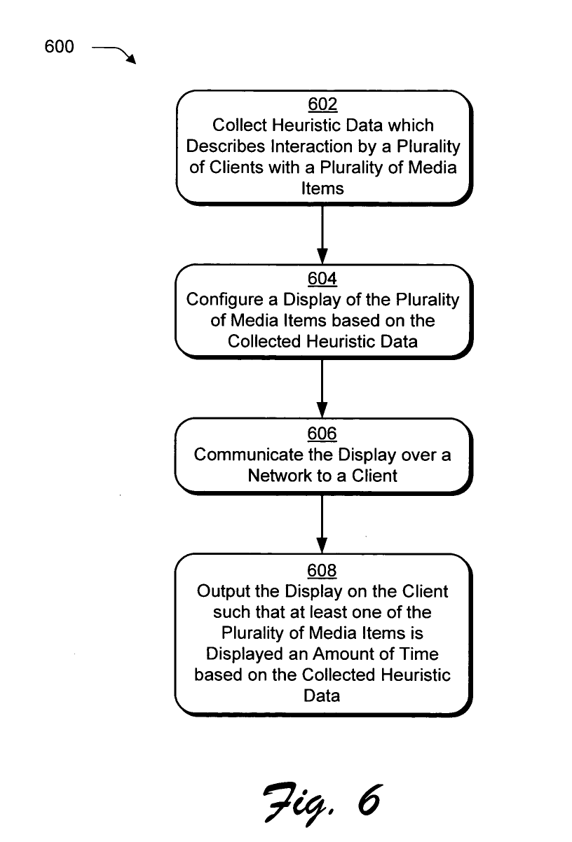

In a further implementation, the scrolling module 102 may output a varied-rate scrolling output 104 for a “hands-off” experience. For example, the varied-rate scrolling output 104 may be configured as a television program guide channel having a varied scroll rate, a “scan” feature may be employed by a radio in which stations are output based on previous user interaction with the stations, and so on, further discussion of which may be found in relation to FIG. 6.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the variable-rate scrolling techniques described below are platform-independent, meaning that the techniques may be implemented on a variety of commercial computing platforms having a variety of processors.

FIG. 2 is an illustration of an environment 200 in an exemplary implementation that is configured to employ the system 100 of FIG. 1 for variable-rate scrolling of media items. The environment 200 includes a media provider 202 that is communicatively coupled to a plurality of clients 204(x) (where “x” can be any integer from one to “X”) over a network 206. The clients 204(x) may be configured in a variety of ways. For example, one or more of the clients 204(x) may be configured as a computing device that is capable of communicating over the network 206, such as a desktop computer, a mobile station, an entertainment appliance, a set-top box 208 communicatively coupled to a display device 210 as illustrated, a wireless phone, a digital music player, and so forth. The client 204(x) may range from a full resource device with substantial memory and processor resources (e.g., television enabled personal computers, television recorders equipped with hard disk) to a low-resource device with limited memory and/or processing resources (e.g., traditional set-top boxes). For purposes of the following discussion, the client 204(x) may also relate to a person and/or entity that operate the client. In other words, client 204(x) may describe a logical client that includes a user, software and/or a machine.

The network 206 is illustrated as the Internet, and may include a variety of other networks, such as an intranet, a wired or wireless telephone network, a broadcast network which may include a backchannel to provide two-way communication, and so forth. Additionally, although one media provider 202 is illustrated for the sake of clarity of the figure, a plurality of media providers may also be included in the environment 200.

The media provider 202 includes a plurality of media items 212(a), where “a” can be any integer from 1 to “A”. The media items 212(a) may include a variety of data, such as streaming media (e.g., television programming and pay-per-view movies), one or more results of remote application processing, and so on. The media items 212(a) are communicated over a network 214 to a head end 216. The network 214 may be the same as or different from network 206. For example, the network 214 may be configured as a private subnet while the network 206 is configured as the Internet.

Media items 212(a) communicated from the media provider 202 over the network 214 are received by the head end 216 and included with a plurality of media items 218(b), where “b” can be any integer from “1” to “B”, which are stored on the head end 216. Thus, the media items 218(b) may be the same as or different from the media items 212(a) received from the media provider 202. Media item 218(b), for instance, may include additional data for streaming to the client 204(x), may be compressed using one or more data compression techniques by the head end 216, may be encrypted, and so forth. For example, the plurality of media items 218(b) may include a television program 220 received from the media provider 202, an electronic program guide 222 generated by the head end 216, and other 224 media items, such as EPG data, downloadable songs, and so on.

The client 204(x) may be configured in a variety of ways to receive the media items 218(b) from over the network 206, such as for immediate output (e.g., an output of a television broadcast) and/or recording (e.g., when the client 204(x) is configured as a digital video recorder). Thus, the media items 218(b) may be included with a plurality of media items 226(c) (where “c” can be any integer from one to “C”) which are stored on the client 204(x). The client 204(x) includes hardware and software to transport and decrypt media items 218(b) received from the head end 216 for rendering by the display device 210. Although a display device 210 is shown, a variety of other output devices are also contemplated, such as speakers.

The client 204(x) includes a navigation module 228(x) that is executable on the client 204(x) to manage use of media items, e.g., playback of the media items. For example, the navigation module 228(x) may provide playback of media items 226(c) that are available locally on the client 204(x). In another example, the navigation module 228(x) is executable on the client 204(x) to retrieve media items 218(b) stored over a network 206, e.g., on the head end 216.

To navigate through this wide variety of media items to locate a particular content item of interest (e.g., locally on the client 204(x), remotely from the head end 216, and so on), the environment 200 may support electronic program guide (EPG) functionality. For instance, one or more of the media items 218(b) may be configured as EPG data for communication to the client 204(x). In an implementation, the EPG data is broadcast utilizing a carousel file system. The carousel file system repeatedly broadcasts the EPG data over an out-of-band (OOB) channel to the client 204(x) over the network 206. The client 204(x) may then store the broadcast EPG data received over the network 206 as one of the plurality of media items 226(c). To generate an EPG 140, the client 204(x) executes a module (e.g., the navigation module 228(x)) that examines and configures the EPG data into a form that suitable for output to and rendering by the display device 210. The generated EPG may be configured to describe media items that are available from various locations, such as the media item 218(b) available from the head end 216, media item 226(c) stored locally on the client 204(x), and so on.

In another implementation, the EPG 222 is formed from EPG data at the head end 216 and then distributed to the client 204(x). For example, the head end 216 may execute a media module 230 on a distribution server 232 to generate the EPG 222 from EPG data. The EPG 222 may be configured in a variety of ways, such as a particular EPG for each particular client that is communicatively coupled to the head end 216, a generic EPG representing each of the media items 218(b), and so on. Distribution from the head end 216 to the client 204(x) may be accommodated in a number of ways, including cable, RF, microwave, digital subscriber line (DSL), and satellite.

The media module 230 is also executable to manage distribution of the plurality of media items 218(b). For instance, the media item 218(b) may be configured as a video-on-demand (VOD), a pay-per-view movie, and so on. Therefore, the media module 230, when executed, may provide digital rights management of the plurality of media items 218(b) to the plurality of clients 204(x), such as based on respective subscription rights of the plurality of clients 204(x).

Both the navigation module 228(x) and the media module 230 are illustrated as include a respective scrolling module 234(x), 236. The scrolling modules 234(x), 236 may or may not correspond to the scrolling module 102 of FIG. 1, i.e., may or may not include all of the previously described functionality. For example, the scrolling module 234(x) may be executed on the client 204(x) to monitor client interaction with a plurality of media items, e.g., media item 226(c), media item 218(b), and so on. The scrolling module 234(x) may then collect client heuristics 238(x) which describe this interaction, such as characteristics of the particular media item (e.g., genre), duration of the media item which was output by the client 204(x), and so on. The scrolling module 234(x) may then utilize the client heuristics 238(x) to vary a scroll rate of a plurality of media items, e.g., media items 226(c), media items 218(b), and so on.

The client heuristics 238(x) may also be collected by the head end 216 from the plurality of clients 204(x), which is illustrated as the plurality of client heuristics 240(y), where “y” can be any integer from one to “Y”. The scrolling module 236 of the distribution server 232 may also utilize the client heuristics 240(y) in a variety of ways. For example, the client heuristics 240(y) may be utilized to vary a scroll rate of media items broadcast by the head end 216, such as a channel listing. In another example, the client heuristics 240(y) may be processed and the results of which communicated to each of the plurality of clients 204(x) such that the scrolling modules 234(x) of the respective clients 204(x) may leverage the described experience of other clients. For instance, certain media items may be viewed by very few of the plurality of clients 204(x), and therefore this may be utilized to vary the scroll rate by each of the clients 204(x). Additionally, one or more of the clients 204(x) may address this data differently, such as a client that frequently views the media item may still output that media item for a relatively longer amount of time than the amount of time utilized by the other clients to output the media item.

In the environment 200 of FIG. 2, the distribution server 232 is illustrated as including a processor 242 and a memory 244. Additionally, the plurality of clients 204(x) is illustrated as client devices which include a respective processor 246(x) and a respective memory 248(x). Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 244, 248(x) is shown, respectively, for the distribution server 232 and the clients 204(x) a wide variety of types and combinations of memory may be employed, such as random access memory (RAM), hard disk memory, removable medium memory, and so forth.

Exemplary Procedures

The following discussion describes variable-rate scrolling techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 3 is a flow diagram depicting a procedure 300 in an exemplary implementation in which a scroll rate is adjusted for output of a plurality of media items based on monitored client interaction. Client interaction with a plurality of media items is monitored (block 302). For example, the client 204(x) may execute the scrolling module 234(x) to determine an amount of time spent by the client 204(x) in outputting one of more of the plurality of media items 226(c) stored locally on the client 204(x) and/or obtained remotely from the head end 216 over the network 206, e.g., media items 218(b). The monitored client interaction may also determine characteristics of the media items being output by the client 204(x), such as title, duration, genre (e.g., comedy, sporting event, action/adventure, news, documentary, romance, etc.), and so on.

Heuristic data is stored which describes the monitored interaction (block 304). For example, a table may be constructed having a plurality of time values, each of which indicates an amount of time a respective one of a plurality of media items were output by the client.

An input is received for outputting one or more of the plurality of media items (block 306). A variety of inputs may be received. For example, the client may receive a “channel plus” (CH+) or “channel minus” (CH−) input from a television remote control, an input from a “scan” button on a radio, and so on. In an implementation, a single and constant input is provided, e.g., pressing and holding the “CH+” button.

A scroll rate for output of the plurality of items is adjusted based on the stored heuristic data (block 308) and the plurality of media items are output having the adjusted scroll rate (block 310). For instance, the scroll rate may be adjusted such that the amount of time utilized to output a plurality of media items varies, one to another. Continuing with the previous example, a user may press and hold down the “channel plus” button to cause a display of a plurality of television channels (and more particularly media items broadcast on the television channels) to be scrolled in succession, one after another. The amount of time utilized to display each of the channels is based on the monitored interaction. For instance, a first channel having media items, with which, the client frequently outputs may be output for a longer period of time than another channel that is not frequently output by the client. In this way, a single input may be utilized to initiate and continue a display of the plurality of media items that is varied without receiving another input from the user, e.g., with receiving a varied input from the user. It should also be noted that even though in this example the scroll rate of the channels is varied, this also works to affect the scroll rate of the media items output from those channels.

The plurality of media items may be output to provide the adjusted scroll rate in a variety of ways. For example, as described in the previous example, a successive display of television channels may be configured such that each of the channels is output for different amounts of time. A similar technique may also be utilized in the output of radio stations by a radio. In another example, the plurality of media items may be representations of other media items, such as an electronic program guide, further discussion of which may be found in relation to the following figure.

FIG. 4 is an illustration of an electronic program guide 400 (EPG) in an exemplary implementation in which the scroll rate of the plurality of media items is adjusted by adjusting a display size of one or more of the media items. The EPG 400 includes representation of a plurality of channels 402(1)-402(5) having a plurality of media items 404(1)-404(5), 406(1)-406(5). The EPG 400 of FIG. 4 is displayable at a constant speed, which is illustrated utilizing an arrow 408. As illustrated, channel three 402(3) and media items 404(3), 406(3) are displayed to consume a greater amount of a display area of a display device (e.g., display device 210) than the other channels and media items. Therefore, channel three 402(3) and media items 404(3), 406(3) are displayed for a greater amount of time than the other channels and media items of the EPG 400, e.g., channels 402(1)-402(2), 402(4)-402(5) and media items 404(1)-404(2), 404(4)-404(5), 406(1)-406(2), 406(4)-406(5).

A variety of other techniques may also be utilized to vary a scrolling output. For example, each of the media items may have the same size but the speed of items across a display area of a display device is varied. It should also be noted that a variety of additional formatting techniques may also be utilized to denote which of the media items the client frequently outputs, such as through highlighting, underlining, use of different colors, textures, and so on.

FIG. 5 is a flow diagram depicting a procedure 500 in an exemplary implementation in which a scroll rate is adjusted based upon a characteristic of a media item output by a client. Client interaction with one of a plurality of media items is monitored (block 502). In this example, the one media item is currently being output by the client, such as a television program, a song, and so forth.

A determination is made as to whether the client interacts with the one media item by at least a threshold amount (decision block 504). For example, the threshold may be set such as to distinguish between navigation through a particular media item (e.g., channel surfing) and extended interaction with the media item. If the threshold has not been reached (“no” from decision block 504), the monitoring continues (block 502). When the threshold has been reached (“yes” from decision block 504), a characteristic for the monitored media item is determined (block 506). For example, a genre (e.g., sporting event), actor, plotline, and other characteristics may be determined from metadata included with the media item, an alternative source of data describing the media item (e.g., an EPG), and so on.

An input is received to navigate through the plurality of media items (block 508), such as from a television remote control, a “jog-dial” on a digital musical player, and so on. The scroll rate for navigation through the plurality of items is adjusted based at least in part on the determined characteristic (block 510). For example, media items which share the determined characteristic of the monitored media item may be output for a greater amount of time than media items which do not share the characteristic. For instance, the client may output a sporting event (e.g., a football game) for at least the threshold amount of time. Therefore, when the user desires to navigate through the plurality of media items (e.g., radio stations), media items that involve sporting events are output for a greater amount of time than media items which are not sporting events. In another instance, the characteristic may be utilized for “island hopping” such that channels having the characteristic which are arranged in a grouping (e.g., movie channels from 300-399) are displayed at a rate which is different from channels in other groupings, i.e., islands. A variety of other characteristics may also be utilized without departing from the spirit and scope thereof.

FIG. 6 is a flow diagram depicting a procedure 600 in an exemplary implementation in which heuristic data collected from a plurality of clients is utilized to vary a scroll rate of media items output for display by the plurality of clients. Heuristic data is collected which describes interaction by a plurality of clients with a plurality of media items (block 602). For example, each of the plurality of clients 204(x) may communicate client heuristics 238(x) to the head end 216 of FIG. 2, which are stored collectively as the plurality of client heuristics 240(y).

A display of the plurality of media items is configured based on the collected heuristic data (block 604). For example, the scrolling module 236 of the distribution server 232 may be executed to generate the EPG 400 of FIG. 4 based on the client heuristics 240(y). Size (i.e., amount of display area) of the media items is adjusted based on the collective experience of the plurality of clients 204(x). The display is then communicated over a network to a client (block 606). The display is output on the client such that at least one of the plurality of media items is displayed an amount of time based on the collected heuristic data (block 608). For example, the EPG generated by the head end 216 may be provided on a particular television channel for broadcast to the plurality of clients. To output the EPG, the client tunes to the particular television channel, which scrolls the plurality of media items across the display device. It should be noted that in this instance, the scroll rate of the display is varied regardless of additional inputs received from the client. In other words, even though the client may have been one of the clients which provided client heuristic data, the scroll rate is adjusted and displayed without further input from the client, such as without receiving a variable input from the client.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
monitoring client interaction with a plurality of media items; and
varying a scroll rate of an output of the plurality of media items based on the monitoring.

2. A method as described in claim 1, wherein:
the output of the plurality of media items is performed upon receipt of an input for navigation through the plurality of items; and
the varying of the scroll rate is performed independent of the input.

3. A method as described in claim 1, further comprising receiving a single input from the client to output the plurality of media items, wherein the scroll rate of the output of the plurality of media items is varied without receiving another input from the client.

4. A method as described in claim 1, wherein:
the monitoring of the client interaction includes determining an amount of time at least one said item was output for display by the client; and
the varying of the scroll rate is performed such that the at least one said media item is output for a greater amount of time than an amount of time utilized to output another said media item.

5. A method as described in claim 4, wherein the monitoring, when performed, determines that the client interacts with the other said media item for an amount of time which is less than the amount of time that the client interacts with the at least one said media item.

6. A method as described in claim 1, wherein the plurality of media items are output as an electronic program guide.

7. A method as described in claim 1, wherein one or more of the media items are an audio file.

8. A method as described in claim 1, wherein:
one or more of the media items are television programs; and
the one or more media items, when output, are displayed in succession, one after another.

9. A method as described in claim 1, wherein one or more of the media items are stored locally on the client.

10. A method as described in claim 1, wherein:
the monitoring is based on data received from a plurality of said clients; and
the output of the plurality of media items having the varied scroll rate is broadcast to the plurality of said clients.

11. A method as described in claim 1, wherein:
the monitoring includes determining a genre of at least one said media item, with which, the client has interacted; and
the varying is based at least in part on the determined genre.

12. A method as described in claim 1, wherein:
the plurality of media items are arranged into a plurality of groups; and
the varying is based at least in part on the interaction of the client with one or more media items included in at least one said group.

13. A method comprising:
configuring a display of representations of a plurality of media items such that a scroll rate of the display of one or more said representations is varied based on one or more characteristics shared by the one or more said media items; and
outputting the display for rendering by a plurality of clients.

14. A method as described in claim 13, wherein:
the display is an electronic program guide; and
at least one said media item is a television program.

15. A method as described in claim 13, further comprising determining an amount of time at least one said item was output for display by at least one said client.

16. A method as described in claim 13,
one or more of the media items are television programs; and
the one or more media items are displayable in succession, one after another, on a respective one of a plurality of television channels.

17. A method as described in claim 13, wherein the configuring and the outputting are performed by a head end.

18. A method as described in claim 13, further comprising determining a characteristic of at least one said media item, with which, a respective said client has interacted, and wherein the scroll rate is varied for one or more said content items having the determined characteristic.

19. One or more computer readable media comprising computer executable instruction that, when executed on a computer, direct the computer to vary a scroll rate of plurality of media items based on one or more characteristics shared by one or more said media items.

20. One or more computer readable media as described in claim 19, wherein the scroll rate is varied such that an amount of time one said media item is displayed is different than an amount of time another said media item is displayed.
